(19) United States
(12) Patent Application Publication
(10) Pub. No.: US 2003/0233317 A1
(43) Pub. Date: Dec. 18, 2003

(54) Methods and systems for transferring funds

(75) Inventor: James S. Judd, Wyckoff, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NYCE Corporation, Woodcliff Lakes, NJ (US)

(21) Appl. No.: 10/210,906

(22) Filed: Aug. 2, 2002

Related U.S. Application Data
(63) Continuation-in-part of application No. 10/060,480, filed on Jan. 30, 2002.
(60) Provisional application No. 60/265,550, filed on Jan. 30, 2001.

(51) Int. Cl. G06F 17/60

(52) U.S. Cl. 705/39

(57) ABSTRACT

Methods and systems are provided that permit a transfer of funds in real time, including among accounts held at different financial institutions and among accounts of different types, such as credit accounts and noncredit accounts. A network links multiple financial institutions and routes information related to requested transfers through the network. Protocols ensure that the account from which funds are being drawn in the transfer is able to support the withdrawal and that the account to which funds are being deposited is a valid account without derogatory marks.

### CROSS-REFERENCES TO RELATED APPLICATIONS

This application is a continuation-in-part application claiming priority to U.S. patent application Ser. No. 10/060,480, entitled “PAYMENT SYSTEM AND METHOD,” filed Jan. 30, 2002 by James Judd, which is a nonprovisional application claiming priority to U.S. Pat. Appl. No. 60/265,550, entitled “PAYMENT SYSTEM AND METHOD,” filed Jan. 30, 2001 by James Judd, the entire disclosures of both of which are incorporated herein by reference for all purposes.

### BACKGROUND OF THE INVENTION

This application relates generally to methods and systems for transferring funds. More specifically, this application relates to methods and systems for transferring funds between accounts at financial institutions.

In any economy, there is a general need for methods of transferring funds between parties as a mechanism for valuing and paying for goods and services. Traditionally, such transfers have taken place by using cash or some form of negotiable instrument, such as a check or bank draft. These mechanisms are often inconvenient for a variety of reasons, particularly when they are used as parts of transactions between separated parties. The risk of theft greatly deters the use of mail to send cash, and mailed transfers are in any event generally considered to be both slow and unreliable. Another factor that discourages the use of mailed checks for transactions is the existence of continually increasing peripheral costs in the form of postage, envelopes, and the cost of producing the checks themselves. In addition, the recent development of on-line commerce has made the inconvenience of mailed transfers particularly acute.

One response to these factors has been the development of electronic methods for fund transfers. For example, it is possible for funds to transferred electronically using wire-transfer methods. Such wire transfers typically require that customers interact with an intermediary who arranges the transfer. The customer sending funds provides the funds to the intermediary, which then makes them available for receipt by the receiving customer. These processes require registration of the parties and confirmation procedures that are time consuming and cumbersome. While they generally provide access to funds more quickly than do checks, the cost of wire transfers is high and the limited infrastructure available to support them restricts their widespread use. These processes are therefore particularly unsatisfactory for a high volume of small transactions. A related process is the Automated Clearing House direct-deposit system, which permits commercial entities in the United States to deposit funds directly to bank accounts. This system is unavailable for use in the vast majority of transactions because of its limitation to commercial entities.

With respect to internet-based transactions, currently available systems follow a common paradigm. When a payment is to be made for an internet purchase, an intermediate organization is authorized to deduct funds from a credit card or bank account and to hold those funds for subsequent delivery by a recipient. Generally, collection by the recipient takes place only after the recipient has been notified that funds are being held and the recipient only obtains complete control over those funds after providing additional instructions to the intermediary.

There is, thus, a general need in the art for methods and systems that facilitate the transfer of funds, particularly among non-commercial-entities.

### BRIEF SUMMARY OF THE INVENTION

Embodiments of the invention are thus provided that permit the transfers of funds in real time, including among accounts held at different financial institutions and among accounts of different types, such as credit accounts and noncredit accounts. Embodiments use a network that links a plurality of financial institutions and routes information related to requested transfers through the network. Protocols may be implemented to ensure that the account from which funds are being drawn in the transfer is able to support the withdrawal and that the account to which funds are being deposited is a valid account without derogatory marks.

Thus, in a first embodiment, a method is provided for mediating a transfer of funds from a sender account to a receiver account. A transfer request is received from a sender that identifies both the sender account and the receiver account. Each of these accounts is managed by one of the plurality of financial institutions connected with the network. A first instruction is issued to debit the sender account in accordance with the transfer request and a second instruction is issued to credit the receiver account in accordance with the transfer request. At least one of the first and second instructions is issued through the network for implementation substantially contemporaneously with receipt of the transfer request.

A variety of different acquisition models, by which the transfer request is initiated by the sender, are within the scope of the invention. For example, in one embodiment, the transfer request is received from a device associated with an acquiring financial institution, such as through an ATM. The acquiring financial institution may be the financial institution that manages the sender account, in which case receipt of the transfer request may also confirm that the sender account includes sufficient funds to execute the transfer request. Alternatively, the acquiring financial institution may be the financial institution that manages the receiver account, in which case receipt of the transfer request may also confirm that the receiver account is a valid account without derogatory marks. In another alternative, the acquiring financial institution may be connected with the network but manage neither the sender account nor the receiver account. In still another embodiment, the transfer request may be received from a device linked with the network but not specifically associated with any of the plurality of financial institutions, thereby permitting transfers to be initiated through the Internet, through a DTMF processor, through a cable processor, or through another such processor.

The methods of the present invention may be embodied in a computer-readable storage medium having a computer-readable program embodied therein for directing operation of a computer system. Such a computer system may include a processor and a communications device. The computer-readable program includes instructions for operating the computer system to mediate a transfer of funds in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic diagram providing an overview of a system in accordance with an embodiment of the invention;

FIG. 2 provides a schematic overview of a computer system on which methods of the invention may be embodied;

FIG. 3 is a flow diagram that illustrates the transfer of funds in accordance with an embodiment of the invention;

FIG. 4A is a schematic illustration of an arrangement in which the sending institution is the acquiring institution

FIG. 4B is a flow diagram illustrating an embodiment of the invention for transferring funds in which the sending institution is the acquiring institution;

FIG. 5A is a schematic illustration of an arrangement in which the receiving institution is the acquiring institution;

FIG. 5B is a flow diagram illustrating an embodiment of the invention for transferring funds in which the receiving institution is the acquiring institution;

FIG. 6A is a schematic illustration of an arrangement in which a third-party institution is the acquiring institution;

FIG. 6B is a flow diagram illustrating an embodiment of the invention for transferring funds in which a third-party institution is the acquiring institution; and

FIG. 7 is a flow diagram illustrating an embodiment of the invention for transferring funds without including an acquiring institution.

### DETAILED DESCRIPTION OF THE INVENTION

Embodiments of the invention provide methods and systems for transferring funds between accounts held at financial institutions. In certain embodiments, the funds may be transferred in real time, even if the accounts are held at different financial institutions. Moreover, embodiments permit the transfer of funds between accounts without requiring that the customer ever interact with the financial institution(s) that hold the accounts; in such embodiments, the transfer may be effected from a third-party financial institution or may be effected remotely, such as through an internet connection, telephone connection, cable connection, or other type of network connection.

A number of terms are used consistently herein to describe the nature of a transfer of funds in accordance with embodiments of the invention. It is generally contemplated that such a transfer is effected by debiting funds from a “sender account” held at a “sending financial institution” and by crediting the funds to a “receiver account” held at a “receiving financial institution”. A “financial institution” is considered to be any entity that manages accounts that hold funds. Accordingly, examples of sending and receiving financial institutions include banks, credit unions, and the like. Examples of the sender account and receiver account include savings accounts, checking accounts, credit accounts and the like. The possibility of having one or both of the sender and receiver accounts be a credit account permits transfers that increase a credit balance of the sender account and/or reduce a credit balance of the receiver account. While it is often expected that the sending and receiving financial institutions comprise different institutions, this is a not a requirement of the invention and they may comprise the same institution.

Information regarding the transfer of funds may be collected in a variety of different ways in different embodiments. In some such embodiments, this information is collected by a device, such as an automatic teller machine (“ATM”), associated with either the sending financial institution or the receiving financial institution. In other embodiments, the information may be collected with a device associated with a third-party financial institution. In all such cases, the financial institution associated with collection of the transfer information is referred to herein as the “acquiring financial institution.” In other embodiments, the transfer information may be collected without direct involvement of an acquiring financial institution.

This versatility is achieved by linking the financial institutions involved in possible transfer actions by a network according to a common protocol. In embodiments where an acquiring financial institution is used, access to the network arrangement is provided by the acquiring financial institution. In other embodiments where no acquiring financial institution is used, access to the network arrangement is provided by other means, such as with an Internet network, a cable network, a telephone network, or the like.

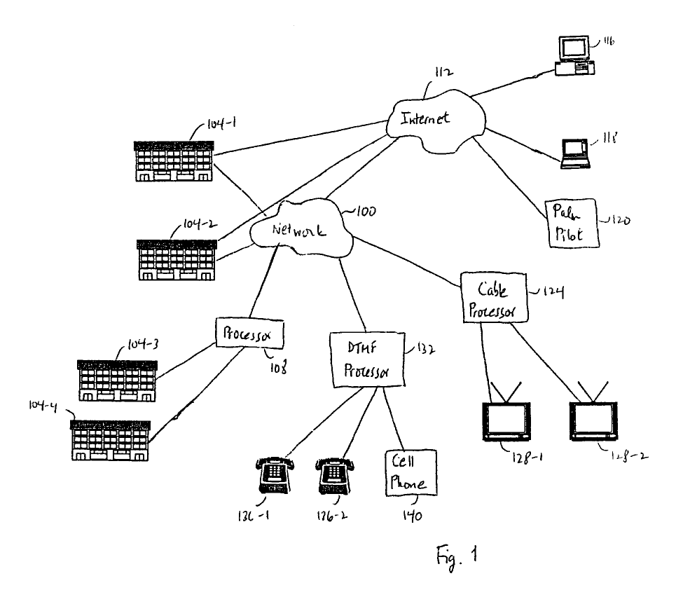

FIG. 1 provides a schematic diagram that summarizes several aspects of such an arrangement. The common-protocol network through which transfer information is routed is denoted 100. This network may be interfaced directly with financial institutions 104, such as shown for financial institutions 104-1 and 104-2, or may be interfaced through one or more intermediate processors 108, such as shown for financial institutions 104-3 and 104-4. All of these financial institutions are part of the system on an equal basis and may therefore act as the sending financial institution, the receiving financial institution, and/or the acquiring financial institution. When transfer information is initiated with an acquiring financial institution, it may be done through an ATM, at a teller station, at a kiosk, or similar device.

To enable transfers without the use of an acquiring financial institution, the network 100 may also be connected with other intermediate processors equipped to interact with other types of devices. For example, an interface between the network 100 and the Internet 112 permits transfer information to be initiated from such devices as personal computers 116, laptops 118, palm pilots 120, and similar devices. An alternative intermediate processor comprises a cable processor 124, which may be used to provide a customer with a connection through a television 128 with the network 100. Another alternative intermediate processor comprises a dual-tone multiple-frequency (“DTMF”) processor 132 that detects DTMF tones provided by touch-tone telephones. Such a processor permits transfer information to be communicated by a customer to the network 100 through a telephone 136, cell phone 140, or similar device. Still other alternative processors may be used to accommodate still other methods for providing transfer information to the network 100. For example, a voice-response processor may be interfaced with the network 100 to permit transfer information to be provided with voice commands, such as through a telephone, cell phone, kiosk, or similar device.

The figure notes that in some instances, one or more of the processors that interface with the network 100 may additionally interface directly with one or more of the financial institutions 104. In the specific example shown, the Internet 112 is used to provide a direct connection with financial institutions 104-1 and 104-2. In such cases, one of the connected financial institutions 104 may act as an acquiring financial institution, although the transfer information is acquired through a device not under the direct control of the financial institution 104. For example, a bank that provides on-line Internet banking services may permit a customer to initiate a transfer remotely using a computer 116, laptop 118, palm pilot 120, or similar device instead of requiring that it be initiated from an ATM or teller station. In such instances, the bank acts as an acquiring financial institution in the same fashion as if the transfer were initiated from a device under its direct control. While this illustration is made where the Internet 112 interfaces directly with the financial institutions, the same principles apply for any processor. Any of the processors may interface directly with some or all of the financial institutions 104, permitting a financial institution to act as an acquiring financial institution even though the transfer function is initiated with a device not under its direct control.

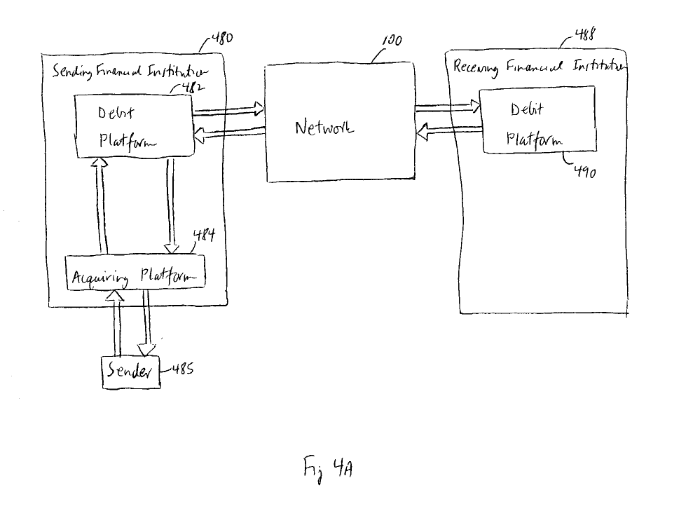

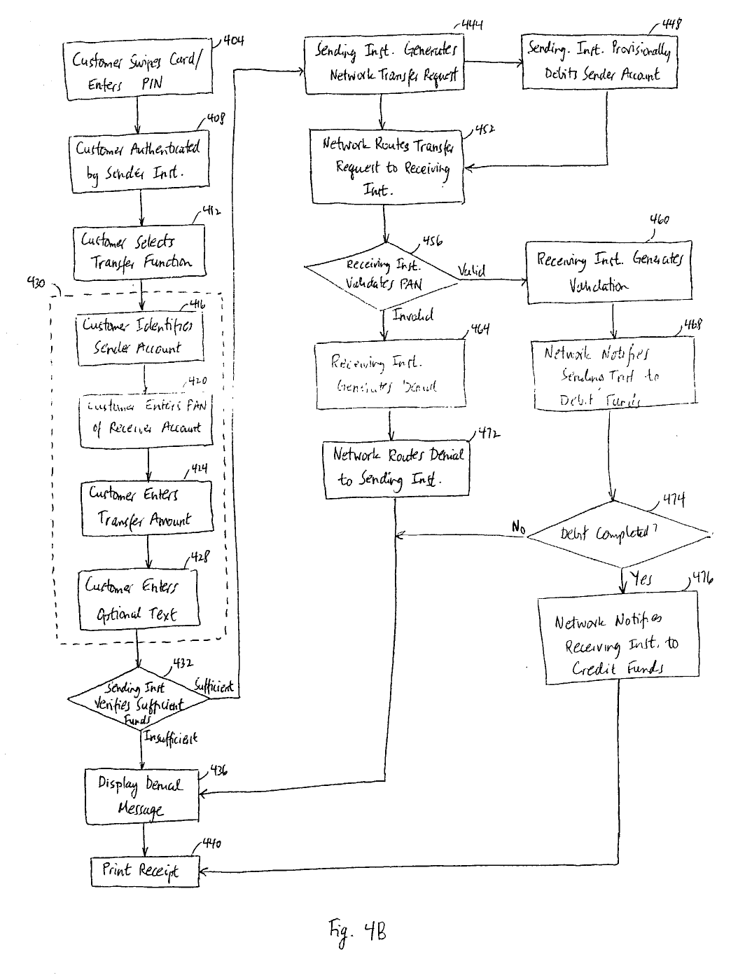

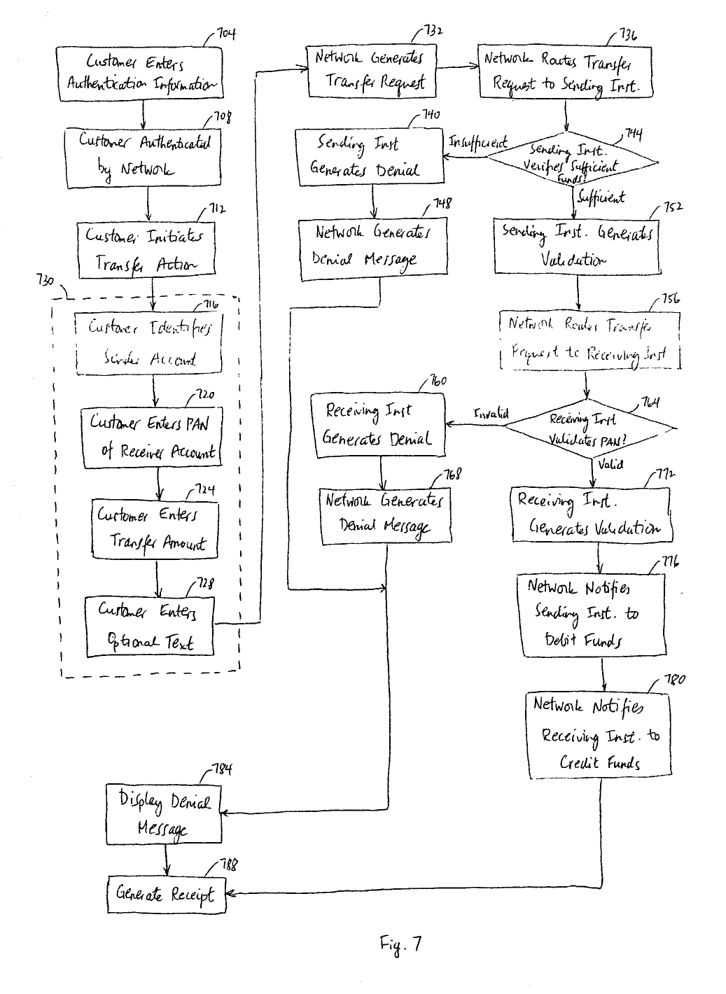

The functions performed by an acquiring financial institution in embodiments of the invention are described below in connection with FIGS. 4, 5, and 6 respectively where the acquiring financial institution is the sending financial institution, the receiving financial institution, and a third-party financial institution. These embodiments correspond both to those situations where the transfer function is initiated on a device directly controlled by the acquiring financial institution and where the transfer function is initiated on a separated device that interfaces with the acquiring financial institution through an intermediary processor. Embodiments in which the intermediary processor interfaces with the network 100 correspond to embodiments in which no acquiring financial institution is used and are described below in connection with FIG. 7.

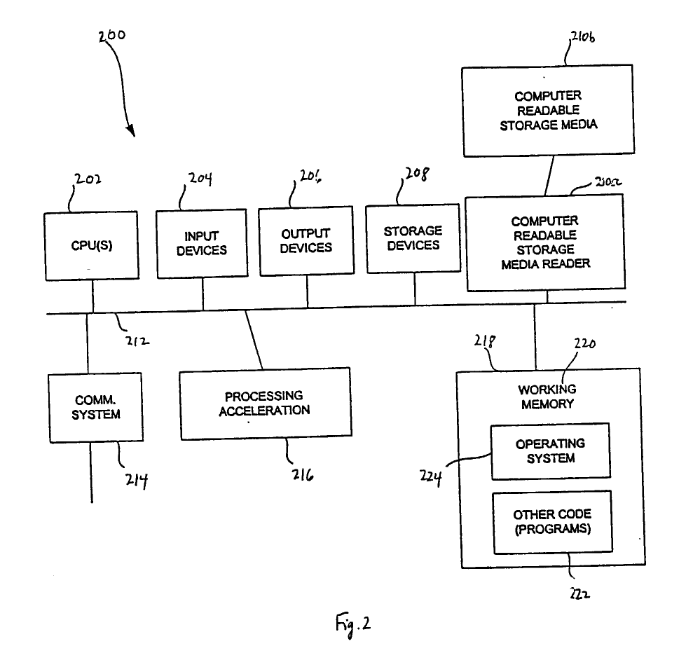

Functions performed by the network may be implemented with a computer system, an exemplary structure for which is shown schematically in FIG. 2. This figure broadly illustrates how individual system elements may be implemented in a separated or more integrated manner. The computer system 200 is shown comprised of hardware elements that are electrically coupled via bus 212, including a processor 202, an input device 204, an output device 206, a storage device 208, a computer-readable storage media reader 210a, a communications system 214, a processing acceleration unit 216 such as a DSP or special-purpose processor, and a memory 218. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with the computer system 200, such as with processor 108, the Internet 112, a cable processor 124, and/or a DTMF processor 132, among others.

The computer system 200 also comprises software elements, shown as being currently located within working memory 220, including an operating system 224 and other code 222, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

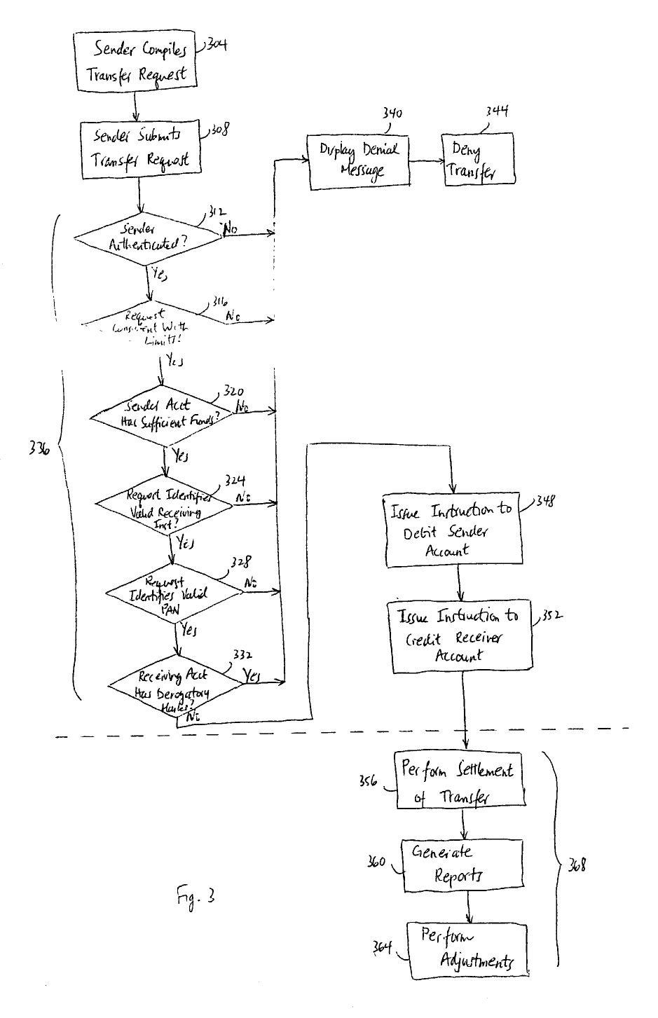

A general overview of embodiments of the invention illustrating features common to arrangements for acquisition of transfer instructions is provided in FIG. 3; FIGS. 4-7 provide more detailed illustrations of specific acquisition arrangements. As indicated in FIG. 3, the method may begin with the sender compiling a transfer request at block 304. Typically such a transfer request includes at least identifications of the sender and receiver accounts and the amount to be transferred. It may also include additional information, such as an optional text message to be conveyed to the receiver to indicate why funds are being transferred. There are a variety of methods by which the identifications of the sender and receiver accounts may be collected. For example, in one embodiment, magnetic stripes on one or multiple cards associated with the two accounts are swiped. Alternatively, the account identifications may be collected through optical scanning of a check or other instrument that identifies one or both accounts, through manual key entry, through direct reading of the information from a chip card (“smart card”), etc. Some of these techniques for collecting the account identifications are discussed in greater detail with respect to FIGS. 4-7, but the invention is not limited by such information-collection techniques. After the transfer request has been compiled, it is submitted by the sender at block 308. Such submission may be through a device controlled by an acquiring financial institution or may be through an independent device connected with the network 100 depending on the embodiment.

After submission of the transfer request, a number of validation checks may be performed to determine whether to approve or deny the transfer request. Some possible validation checks are indicated in FIG. 3 and identified generally by reference numeral 336. These checks may be performed by the device that performs the submission at block 308, by a device controlled by an acquiring financial institution, by a device controlled by the sending financial institution, by a device controlled by the receiving financial institution, by the network, and/or by another device in different embodiments. For example, at block 312, a check is made whether the sender is properly authenticated. This is done to ensure that the person initiating the transfer request is authorized to debit funds from the sender account. If the sender cannot be authenticated, a denial message is displayed to the sender at block 344 and the transfer request is denied at block 344.

If the sender is properly authenticated, a determination is made at block 316 whether the transfer request is consistent with any transfer limits that may be imposed. For example, ATMs controlled by financial institutions are often subject to specific transaction limits to mitigate the effect of any potential fraud. In some instances, these limits may differ, such as in the case where the sender financial institution (“Bank A”) establishes a transaction limit of $1000 and the receiver financial institution (“Bank B”) establishes a transaction limit of $500. In one embodiment, the transaction limit of the sender financial institution governs any transaction so that a transfer request of $600 from an account at Bank A to an account at Bank B would be approved. In another embodiment, the lower transaction limit of the involved financial institutions governs so that such a $600 transfer request from an account at Bank A to an account at Bank B would be denied. In still other embodiments, transfer requests initiated in accordance with the invention are subject to a uniform limit imposed by the network; if such a uniform limit were $750, the $600 transfer request between any accounts would be approved. If the transfer request is to be denied because it is inconsistent with established transaction limits, a message to that effect is displayed at block 340 and the transfer is denied at block 344.

If the transfer request is within established limits, a validation check is made at block 320 to ensure that the sender account has sufficient funds. Since the transfer is performed in real time, if the sender account comprises a noncredit account, it must actually have cleared funds that are sufficient and available for the transfer to be approved. If the sender account is a credit account, it is deemed to have sufficient funds if the transfer amount is no greater than the available credit amount. If there are not sufficient funds in the sender account, a suitable denial message is displayed at block 340 and the transfer is denied at block 344.

Less scrutiny is generally needed for the receiver account since it does not require any particular level of funds. However, checks are still performed at block 324 to ensure that the transfer request identifies a valid receiving financial institution, at block 328 to ensure that a valid primary account number (“PAN”) has been identified in the transfer request for the receiver account, and at block 332 to ensure that the receiver account has no derogatory marks. The checks at blocks 324 and 328 may be relatively cursory in some embodiments, verifying only that the PAN has the correct format, i.e. uses numeric data of the proper length. In other embodiments, the checks at blocks 324 and 328 may be more substantial to confirm the validity of the identified account specifically. If any of these validation checks on the receiving account fails, a suitable denial message is displayed at block 340 and the transaction is denied at block 344. Examples of derogatory marks on the receiver account that justify denying the transaction include, for example, indications of fraud, bankruptcy, theft of account information, closure of the account, etc. Such derogatory remarks may be more common, for example, where the receiver account comprises a credit account. Derogatory marks are generally treated as confidential to the receiver and, accordingly, the message displayed to the sender at block 340 is generic, e.g. “Transfer Denied.”

If all of the validation checks for the transfer request are satisfactory, the transfer is executed at blocks 348 and 352 respectively by issuing instructions to debit the sender account by the transfer amount and to credit the receiver account by the transfer amount. In some embodiments, a service charge may be applied to the sender account for the transfer so that at block 348 an instruction is issued to debit the sender account by the sum of the transfer amount and service charge.

A number of administrative functions denoted generally by reference numeral 368 may also be implemented that are not considered to be part of the transfer itself, and are therefore included below the dashed line in FIG. 3. These functions may be applied to specific transfers, but generally occur after the transfer functions for multiple transfers have been completed. For example, at block 356, the transfer is settled among the relevant financial institutions. In performing the transfer, two transfer operations are effectively performed. First, the receiving financial institution credits the receiver account and debits a network account. Second, the sending financial institution debits the sender account and credits the network account. Settlement of the transaction comprises ensuring that the credit to the network account by the sending financial institution is equal to the debit to the network account by the receiving financial institution.

It is noted at block 360 that reporting functions may be included to summarize information for analysis of the systems being used. For example, reports may be generated based on activities of certain types of account holders, may be generated based on the types of transfers performed, and/or may be generated based on the activities of specific devices, among other types of reports. Finally, block 364 notes that adjustments may be performed after the transfers have been executed. Such adjustments may sometimes arise directly from errors in the process: the sender account might be debited without the receiver account ever being credited; the receiver account might be credited without the sender account ever being debited; or a processor error may cause an error in the transfer. In other instances, adjustments may arise from activity unrelated to the process itself: the sender may have transferred funds in exchange for goods from the receiver that never arrive or are nonconforming; the sender may have entered incorrect receiver-account information; the sender may have entered the wrong transfer amount; or the receiver may have refused the funds. In such instances, the sender or receiver may report a discrepancy, which may then be corrected by debiting and crediting the appropriate accounts.

While the above description provides an overview of embodiments of the invention, FIGS. 4A-7 illustrate in greater detail how these features are implemented for different ways of acquiring the initial transfer request. FIGS. 4A and 4B correspond to an embodiment in which the sender initiates the transfer request at the sending financial institution, which therefore also acts as an acquiring financial institution. In many instances, such an embodiment may arise where a device controlled by the sending financial institution is used to generate the transfer request, such as with an ATM owned by the sending financial institution. It is also possible, however, for such an embodiment to arise with a non-controlled device, such as described in connection with FIG. 1 where the sending financial institution makes online banking software available to the sender. FIG. 4A shows a schematic illustration of an arrangement of the financial institutions and network and FIG. 4B provides a flow diagram illustrating how the arrangement may be used to effect the transfer request.

Thus, in FIG. 4A, arrows are used to indicate the flow of information through the financial institutions and network. The sender 485 interacts with an acquiring platform 484 controlled by the sending financial institution 480. In one embodiment, the acquiring platform 484 comprises an ATM, but may comprise any other device controlled by the sending financial institution 480 in other embodiments, including those described above. Information from the acquiring platform 484 may be exchanged with a debit platform 482 of the sending financial institution. The network 100 provides a mechanism for the exchange of information between the debit platform 482 of the sending financial institution 480 and the debit platform 490 of the receiving financial institution 488.

In FIG. 4B, a method for mediating a transfer of funds is illustrated, beginning at block 404 where the sender customer 485 provides information that may be used to authenticate himself. In the case where the acquiring platform 484 is directly controlled by the sending financial institution, such as where an ATM is used, this may be accomplished by swiping an ATM, credit, debit, or other card at the device and entering a personal identification number (“PIN”). If the sender 485 is using a remote device, such as a computer running on-line banking software provided by the sending institution, the identification information is provided in accordance with the protocols established by the sending financial institution with the software. However the information is entered, the customer 485 is authenticated from that information by the sending institution at block 408.

At block 412, the customer selects a transfer function, such as on the sending financial institution's ATM device or through software, so that information may be provided to generate the transfer request. The blocks that form part of collecting information for generating the transfer request are denoted collectively by block 430. To generate the transfer request, the customer may identify the sender account at block 416, enter the PAN of the receiver account at block 420, enter the transfer amount at block 424, and perhaps also enter an optional text message to accompany the transfer request at block 428. Identification of the sender account at block 416 may comprise selecting one of a list of accounts accessible by the customer from a menu generated by the sending financial institution. Entering the PAN of the receiver account at block 420 may be performed by manual data entry or by swiping a card that identifies the receiver account, among other methods. The use of cards both to identify the sender account and to identify the receiver account may be especially suitable when the sender owns both the sender and receiver accounts. The information collected within block 430 is ensured to comply with all requirements of form, including specification of a transfer amount that is within any prescribed transaction limits.

Since the sending financial institution 480 is acting as the acquiring financial institution, a check is first made at block 432 to ensure that the sender account identified in block 416 has sufficient funds. This may comprise ensuring that sufficient cleared funds actually reside in a savings or checking account, or may comprise ensuring that the transfer amount specified is no greater than a level of credit available in a credit account. If there are not sufficient funds, a suitable denial message is displayed at block 436 and a receipt of the attempted transfer is generated at block 440.

If the sender account does have sufficient funds for the transfer, a transfer request suitable for transmission over the network 100 is generated by the sending financial institution 480 at block 444. In some embodiments, the sending financial institution 480 may also provisionally debit the sender account by the transfer amount, and perhaps also a service charge, at block 448. Such provisional debiting may provide greater efficiency to the system since the large majority of transfer requests will ultimately proceed. Whether or not such a provisional debiting is performed, the network 100 routes the transfer request to the receiving financial institution 488 at block 452 so that validation checks may performed against the receiver account. In some embodiments, the generated transfer request may be displayed to the customer for verification before routing the transfer request. The validation checks are then performed at block 456 and include verifying that the specified PAN defines a valid receiving financial institution and an account at that receiving financial institution, as well as ensuring that the receiver account does not have any derogatory marks. If there is any such problem with the receiver account, the receiving financial institution 488 generates a denial at block 464 for communication back to the sending financial institution 480 through the network 100 at block 472. This denial is used to display a suitable denial message back through the acquiring platform 484 at block 436 and to generate a receipt of the attempted transfer at block 440.

If the receiving financial institution 488 validates the receiver account at block 456, it generates a validation for the network 100 at block 460. Since both the sender account and the receiver account have now been found to comply with all requirements for the transfer, the transfer request is executed by notifying the debit platform 482 of the sending financial institution 480 to debit funds from the sender account at block 468. Crediting of the funds to the receiver account is generally not performed until verification has been provided from the debit platform 482 of the sending financial institution 480 that the debit has been successfully completed, as checked at block 474. If the debit of the sender account is completed successfully, the receiving financial institution 488 is notified at block 476 to credit funds to the receiver account. A receipt of the transfer is then generated for the customer at block 440.

The receipt that is generated at block 440 is generated both when the transfer is denied and when the transfer is approved and executed. The availability of this receipt permits the customer to provide proof of the transaction in the event of a dispute that might require an adjustment as described in connection with FIG. 3.

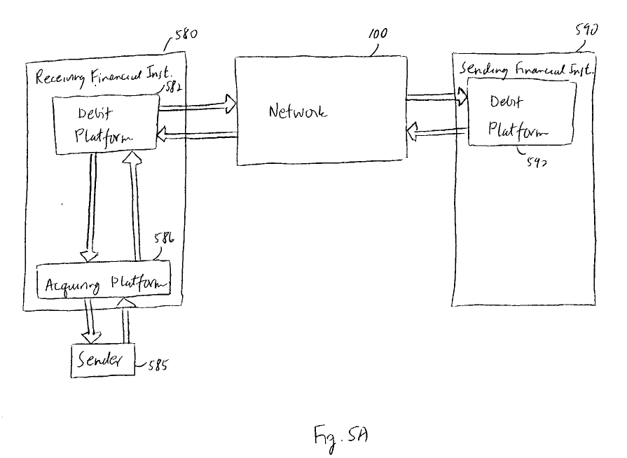

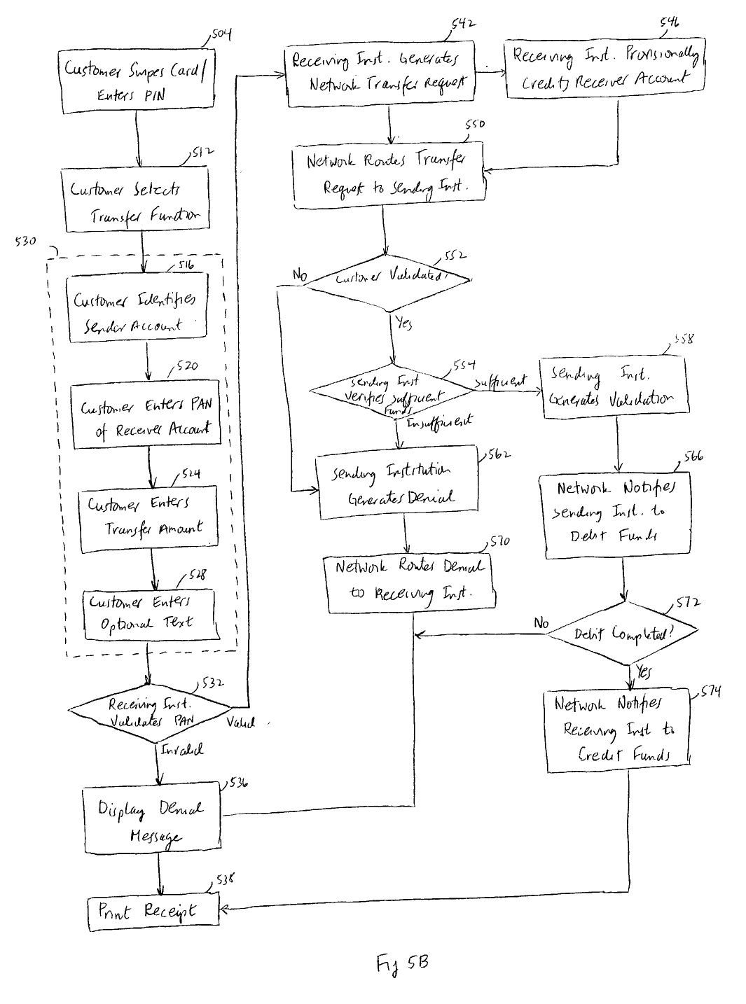

A similar method is used where the receiving financial institution acts as an acquiring financial institution, as shown in FIGS. 5A and 5B, although some differences are apparent because of the type of information that is accessible. As shown in the schematic illustration of FIG. 5A, this arrangement is characterized in that the sender 585 initiates the transfer request with an acquiring platform 586 controlled by the receiving financial institution 580. Such an acquiring platform 586 may comprise any suitable device including, for example, an ATM controlled by the receiving financial institution 580 or through on-line banking software provided by the receiving financial institution 580, among others. Information from the acquiring platform 586 may be exchanged with a debit platform 582 at the receiving financial institution 580, which may itself exchange information with a debit platform 592 at the sending financial institution 590 through the network.

A method for mediating the transfer of funds in this embodiment is shown with the flow diagram of FIG. 5B. At block 504, the sender customer 585 provides information at the acquiring platform 586 that may be used for authentication, such as by swiping a card and entering a PIN at an ATM or by using identification protocols established by the receiving financial institution 580 in its on-line banking software. At block 512, the customer 585 selects a transfer function, such as from the receiving financial institution's ATM device or through software, so that information may be provided to generate the transfer request. The blocks that form part of collecting information for generating the transfer request are denoted collectively by block 530. Similarly to FIG. 4, the customer may identify the sender account at block 516, enter the PAN of the receiver account at block 520, enter the transfer amount at block 524, and perhaps also enter an optional text message to accompany the transfer request at block 528. Since the sender customer 585 is generating the transfer request at the receiving financial institution 580, some of the account types may be unavailable, either at an ATM or in software selections. Accordingly, in one embodiment, a primary or funding account of the sender's is identified as a default for the debit portion of the transfer. Entry of the PAN of the receiver account at block 520 may be performed by any suitable method, including manual data entry or by swiping a card that identifies the receiver account, the desired method perhaps depending on respective ownership of the sender and receiver accounts. The information collected within block 530 is ensured to comply with all requirements of form, including specification of a transfer amount that is within any prescribed transaction limits.

Since the receiving financial institution 590 is acting as the acquiring financial institution, validation checks are first made at block 532 to ensure that the receiver account has been properly identified. This includes verifying that the specified PAN defines the receiving financial institution 580 and an account at that institution, as well as ensuring that the receiver account does not have any derogatory marks. If there is any such problem with the receiver account, a suitable denial message is displayed at block 536 and a receipt of the attempted transfer is generated at block 538.

If the receiver account is validly identified, the receiving financial institution 580 generates a transfer request suitable for transmission over the network 100 at block 542. The transfer request includes identification information for the sender 585 initially obtained at the acquiring platform 586. In some embodiments, the receiving financial institution 580 may also provisionally credit the receiver account by the transfer amount at block 546. Such provisional crediting may provide greater efficiency to the system since the large majority of transfer requests will ultimately proceed. Whether or not such a provisional crediting is performed, the network 100 routes the transfer request to the sending financial institution 590 at block 550 so that the sending financial 590 institution may authenticate the customer 585 at block 552. Such authentication is performed using the identification information included with the transfer request according to the requirements of the sending financial institution 590. In some embodiments, the generated transfer request may be displayed to the customer 585 through the acquiring platform 586 for verification before routing the transfer request through the network 100.

If the customer 585 is authenticated at block 552, a check is made at block 554 whether the sending account includes sufficient funds. Checking the sender account may comprise ensuring that sufficient cleared funds actually reside in a noncredit savings or checking account, or may comprise ensuring that the transfer amount in the transfer request is no greater than a level of credit available in a credit account. The sending financial institution 590 generates a denial of the transfer at block 562 for routing back to the receiving institution 580 at block 570 either when the customer 585 cannot be authenticated or when the sending account lacks sufficient funds. This denial is then used to display a suitable denial message with the acquiring platform at block 536 and to generate a receipt of the attempted transfer at block 538.

If the sending financial institution 580 determines at block 554 that the sender account comprises sufficient funds for the transfer, it generates a validation at block 558. Since both the sender account and the receiver account have now been found to comply with all requirements for the transfer, the transfer request is executed, first by notifying the sending financial institution 590 to debit funds from the sender account at block 566. If verification is received that the debit has completed successfully at block 572, the receiving financial institution 580 is notified to credit funds to the receiver account at block 574. A receipt of the transfer is then generated for the customer at block 538.

The receipt that is generated at block 538 is generated both when the transfer is denied and when the transfer is approved and executed. The availability of this receipt permits the customer 585 to provide proof of the transaction in the event of a dispute that might require an adjustment as described in connection with FIG. 3.

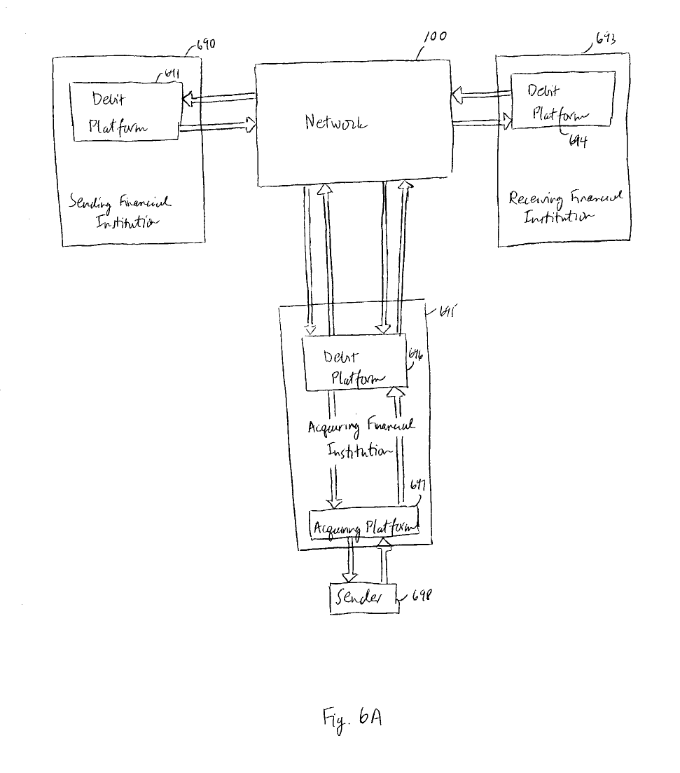

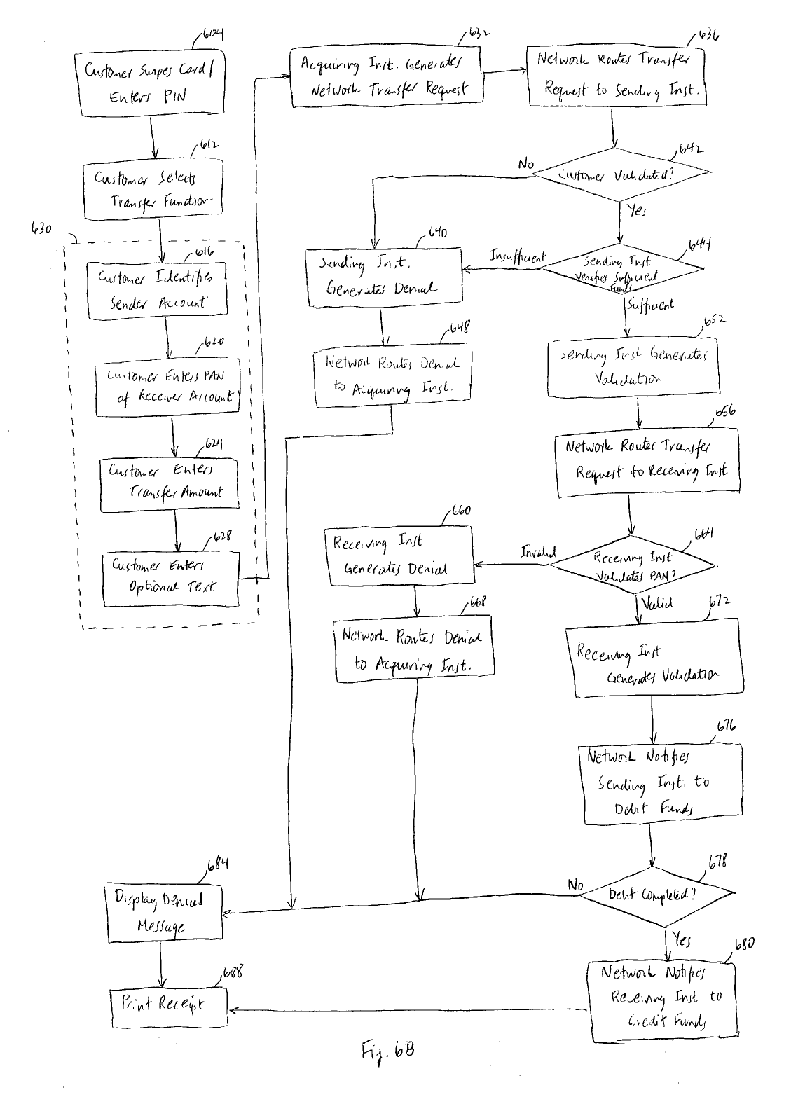

The same basic processes described in connection with FIGS. 4A-5B arc also applicable when the acquiring financial institution is a third-party financial institution, although certain functions may be performed differently to accommodate the fact that the acquiring financial institution is neither the sending financial institution nor the receiving financial institution. FIGS. 6A provides a structural overview of an embodiment in which a third-party financial institution acts as the acquiring financial institution and FIG. 6B provides a flow diagram that outlines how a transfer is mediated in a specific embodiment using such the configuration of FIG. 6A.

As shown in FIG. 6A, the acquiring financial institution 695 may be accessed by the sender customer 698 using an acquiring platform 697 that may be under the control of the acquiring financial institution 695, such as an ATM; alternatively the acquiring financial institution 695 may be accessed with a remote device, such as with a computer running online banking software provided by the acquiring financial institution 695. A debit platform 696 of the acquiring financial institution 695 is configured to exchange information with the acquiring platform 697. The network 100 includes connections not only with the debit platform 696 of the acquiring financial institution 695, but also with a debit platform 691 of the sending financial institution 690 and with a debit platform 694 of the receiving financial institution 693. These connections permit exchanges of information among the separate sending, receiving, and acquiring financial institutions 690, 693, and 695 used in mediating a transfer as shown in FIG. 6B.

As shown in FIG. 6B, the sender customer 698 provides information through the acquiring platform 697 that may be used for authentication at block 604. This may be done, for example, by swiping a card and entering a PIN at an ATM or by using identification protocols established by the acquiring financial institution 695 in its on-line banking software. The customer 698 then selects a transfer function, such as from the third-party acquiring financial institution's ATM device or through software, so that information may be provided to generate the transfer request. The blocks that form part of collecting information for generating the transfer request are denoted collectively by block 630. Similarly to FIGS. 4B and 5B, the customer 698 may identify the sender account at block 616, enter the PAN of the receiver account at block 620, enter the transfer amount at block 624, and perhaps also enter an optional text message to accompany the transfer request at block 628. Since the sender customer 698 is generating the transfer request at a financial institution different from the sending financial institution 690, some of the account types may be unavailable. Accordingly, in one embodiment, a primary or funding account of the sender's is identified as a default for the debit portion of the transfer. Entry of the PAN of the receiver account at block 620 may be performed by any suitable method, including manual data entry or by swiping a card that identifies the receiver account, the desired method perhaps depending on respective ownership of the sender and receiver accounts. The information collected within block 630 is ensured to comply with all requirements of form, including specification of a transfer amount that is within any prescribed transaction limits.

Since the third-party acquiring financial institution 695 does not have direct access to either sender-account information or to receiver-account information, no checks of either account are performed before generating the network transfer request at block 632. This network transfer request is generated by the third-party acquiring financial institution 695 with the information collected within block 630. The network 100 routes the generated transfer request both to the sending financial institution 690 and to the receiving financial institution 693 to perform checks on both the sender and receiver accounts. At least when routing the transfer request to sending financial institution 690, the identification information collected at block 604 is included so that the sending financial institution 690 may authenticate the customer 698. Before routing the generated transfer request, it may be displayed to the customer 698 through the acquiring platform 697 for verification.

Thus, block 636 shows routing the transfer request to the sending financial institution 690. The authentication of the customer 698 is performed at block 642 from the identification information included with the transfer request. If the customer 698 is authenticated, a check is performed at block 644 by the sending financial institution 690 to ensure that the sender account includes sufficient funds. This may comprise ensuring that sufficient cleared funds actually reside in a noncredit savings or checking account, or may comprise ensuring that the transfer amount in the transfer request is no greater than a level of credit available in a credit account. The sending financial institution 690 generates a denial of the transfer at block 640 if the customer 698 cannot be authenticated at block 642 or if the sender account is found not to have sufficient funds at block 644. This denial is routed back through the network 100 to the third-party acquiring institution 695 at block 648. In response to the denial, a suitable denial message is displayed at block 684 and a receipt of the attempted transfer is generated at block 688. If the check at block 644 determines that the sender account does comprise sufficient funds, the sending financial institution 690 instead generates a validation at block 652.

The network 100 routes the transfer request to the receiving financial institution 693 at block 656. Validation checks of the receiver account may then be performed by the receiving financial institution 693 at block 664. These validation checks may include verifying that the specified PAN defines a valid receiving financial institution 693 and an account at that receiving financial institution 693 that does not have any derogatory marks. If there is any such problem with the receiver account, the receiving financial institution 693 generates a denial at block 660 for communication back to the third-party acquiring financial institution 695 at block 668. This denial is used to display a suitable denial message at block 684 and to generate a receipt of the attempted transfer at block 688. If the check at block 664 validates the receiver account, the receiving financial institution 693 generates a validation at block 672.

While the order of steps in many of the flow diagrams described herein may be altered without exceeding the scope of the invention, it is noted particularly with respect to FIG. 6B that there is no necessary order for the checks of the sender and receiver accounts. While the figure shows checking the sufficiency of funds in the sender account at blocks 636-652 being performed before checking the validity of the receiver account at blocks 656-672, these functions may be performed in the opposite order or, preferably, simultaneously.

Once the checks of both the sender and receiver accounts have both produced validations at blocks 652 and 672, the transfer request may be executed. This may be performed by first notifying the sending financial institution 690 to debit funds from the sender account at block 676. Once the debit has been confirmed as completed at block 678, the receiving financial institution 693 is notified to credit funds to the receiver account at block 680. A receipt of the transfer is then generated for the customer at block 688. Some type of receipt is generated regardless of the outcome of the transfer request, permitting the customer to provide proof of the transaction in the event of a dispute that might require an adjustment as described in connection with FIG. 3.

Each of FIGS. 4B, 5B, and 6B has described processes performed when an acquiring financial institution is used to generate the transfer request. It is noted that from the perspective of the customer, there is virtually no difference between any of the three processes, regardless of whether the acquiring financial institution is the sending financial institution, the receiving financial institution, or a third-party financial institution. In all cases, the customer provides information to identify himself, responds to requests to provide details of the transfer to be requested, and receives a receipt indicating whether the transfer was executed or not.

In circumstances where no acquiring financial institution is used, such as illustrated by the flow diagram of FIG. 7, the collection of information to generate the transfer request may be performed by software that interacts directly with the network 100. These embodiments are similar to those described with respect to FIGS. 6A and 6B in which the acquiring financial institution is a third-party financial institution except that the network performs functions as a surrogate for the acquiring financial institution. In these embodiments, the method begins with the customer entering authentication information at block 704. This may be entered with a computational device that is connected with the Internet 112, with a cable device connected with a cable processor 124, with a telephonic device connected with a DTMF processor 132, or with any other device capable of communicating input from the customer to the network 100 through a processor. Authentication of the customer is performed at block 708.

The transfer action may be initiated by the customer at block 712. Such initiation may include prompts to the customer that are coordinated by the intermediate processor. After initiating the transfer action, information is collected for generating the transfer request, denoted generally by block 730. This may include identifying the sender account at block 716, entering the PAN of the receiver account at block 720, entering the transfer amount at block 724, and optionally entering a text message to accompany the transfer request at block 728. All the information provided within block 730 is generally entered in a single fashion consistent with the capabilities of the intermediate processor, such as by manual data entry where the intermediate processor comprises the Internet 112 or with DTMF tones where the intermediate processor comprises a DTMF processor 132. While it is generally expected that the network 100 may provide all possible account types as options to the customer, it is possible that certain account types may be unavailable. In such instances, a primary or funding account of the sender's is identified as a default for the debit portion of the transfer. If a limit is imposed on the size of the transfer, it is usually a uniform limit established at the level of the network 100 rather than individually by the sending and receiving financial institutions.

As in the embodiments where the transfer request is initiated with a third-party acquiring financial institution, there is no direct access to either sender- or receiver-account information. Accordingly, no checks of either account are performed before the network generates the transfer request at block 732. From this point, processing of the transfer request is similar to that described in connection with a third-party acquiring institution. Before routing the generated transfer request both to the sending and receiving financial institutions, it may be presented to the customer for verification. Routing of the transfer request to the sending and receiving financial institutions may proceed sequentially in either order or, preferably, in parallel.

Thus, block 736 indicates that the transfer request is routed to the sending financial institution so that it may verify that the sender account has sufficient funds at block 744. The sender account is considered to have sufficient funds if it comprises a noncredit account that holds cleared funds in excess of the transfer amount or comprises a credit account that has available credit that exceeds the transfer amount. If there are insufficient funds, a denial is generated by the sending financial institution at block 740, thereby prompting the network to generate a denial message at block 748 for transmission to the customer at block 784. If there are sufficient funds, the sending financial institution instead generates a validation at block 752.

Similarly, block 756 indicates that the transfer request is routed to the receiving financial institution so that validation checks may be made of the receiver account at block 764. These validation checks include ensuring that the specified PAN identifies an account without derogatory marks at a valid receiving financial institution. If the receiver account is identified as invalid or as having derogatory marks, the receiving financial institution generates a denial at block 760, thereby prompting the network to generate a denial message at block 768 for transmission to the customer at block 784. If the receiver account is identified as valid and without derogatory marks, the receiving financial institution instead generates a validation at block 772.

If validations have been generated by both the sending and receiving financial institutions, the network 100 notifies the sending financial institution to debit funds from the sender account at block 776 and notifies the receiving financial institution to credit funds to the receiver account at block 780. Whether or not the transfer is executed, a receipt is generated for the customer at block 788. The form of the receipt may vary depending on the type of intermediate processor being used. For example, if the Internet is functioning as the intermediate processor, the network 100 may transmit an electronic receipt. Alternatively, if a DTMF processor is being used as the intermediate processor, an electronic receipt may be stored by the network 100 on storage device 208 of the computer system 200, with a reference number being provided to the customer.

A number of the verification and check functions described above in connection with several different embodiments of the invention permit a transfer to be executed in real time. In certain alternative embodiments, the actual transfer may be deferred to a later time. For example, such a deferred transfer may be used in embodiments if it is determined that the sender account does not have sufficient funds for the transfer, as checked generally at block 320 in FIG. 3 (and more specifically at blocks 432, 554, 644, and 744 in FIGS. 4, 5, 6, and 7 respectively). In such cases, the customer may be presented with an option to defer the transfer until the sender account includes sufficient funds. If the customer elects such an option, the sending financial institution is notified to initiate the transfer automatically when sufficient funds are available in the sender account.

While embodiments have been described above for situations in which a transfer is made from a single sender account to a single receiver account, it will be appreciated that the invention is not limited to such transfer characteristics. More generally, embodiments of the invention permit multiple accounts to be used in a given transfer as sender accounts and/or as receiver accounts. For example, in one such embodiment, funds from a single sender account may be transferred to multiple receiver accounts in proportions directed by the customer. This may be achieved by including multiple PANs to identify the receiver accounts and the relative distributions when the transfer request is compiled, such as at block 304 in the general description of FIG. 3 (and more specifically at blocks 430, 530, 630, and 730 in FIGS. 4B, 5B, 6B, and 7 respectively). Validation checks are then performed on each of the identified PANs by the respective receiving financial institutions at block 328 of FIG. 3 (and at blocks 456, 532, 664, and 764 of FIGS. 4B, 5B, 6B, and 7 respectively). If all the PANs are verified to correspond to existing accounts without derogatory marks, in addition to ensuring that the sender account has sufficient funds, the transfer is executed by notifying the receiving financial institutions to credit each of the receiver accounts by their respective amounts and to debit the sender account by the total amount. If some of the PANs are verified but others are not, the customer may be given an opportunity to revise the transfer request for resubmission.

Similarly, another embodiment permits funds from multiple sender accounts to be transferred to a single receiver account in proportions directed by the customer. Multiple sender accounts may be identified with the relative proportions of funds they are to supply when the transfer request is compiled, such as at block 304 in the general description of FIG. 3 (and more specifically at blocks 430, 530, 630, and 730 in FIGS. 4B, 5B, 6B, and 7 respectively). Ensuring that the identified sender accounts have sufficient funds at block 320 of FIG. 3 (and at blocks 432, 554, 644, and 744 of FIGS. 4B, 5B, 6B, and 7 respectively) comprises determining the funds needed from each of the sender accounts to meet the proportions specified in the transfer request; this information is then used to check each of the sender accounts individually. If all the sender accounts have sufficient funds, in addition to verifying that the specified PAN corresponds to an existing account without derogatory marks, the transfer is executed by notifying each of the sending financial institutions to debit each of the sender accounts by their respective amounts and to credit the receiver account by the total amount. If some of the sender accounts have sufficient funds by others do not, the customer may be given an opportunity to revise the transfer request for resubmission.

These principles may also be applied to allow a customer to compile a transfer request that identifies proportions for multiple sender accounts and proportions for multiple receiver accounts. Checks are performed as described above to ensure that each of the sender accounts has sufficient funds to support their respective portions of the transfer and that only existing accounts without derogatory marks are identified as receiver accounts. The transfer request is then executed by notifying each of the sending financial institutions to debit each of the sender accounts by their respective amounts and to credit each of the receiver accounts by their respective amounts. If the results of the checks prevent any of the sender or receiver accounts from being included in the transfer, the customer may be permitted to revise the transfer request for resubmission.

The ability for embodiments of the invention to perform real-time transfers of funds among accounts held at different financial institutions and among different types of accounts enables a large number of applications. Such transfer capabilities may be used whenever individuals or business wish to exchange funds and receive immediate credit. For example, a buyer at an online auction may send payment to the seller for the goods, with the seller being credited immediately irrespective of whether the buyer pays from a checking or savings account, or even pays on credit. Embodiments of the invention also facilitate group payments, such as payment for a work luncheon, baby shower, or wedding present, and simplify paying for casual services such as lawn mowing or paper delivery. Embodiments of the invention may also provide a substitute for any check- or gift-certificate-based transaction, such as sending money to a child at college or sending money as a gift.

There are certain advantages associated with some embodiments of the invention. One advantage to financial institutions is that some of the costs associated with paper-check and ACH processing may be displaced. An advantage to customers, in addition to the real-time nature of the transfers, is that a common user experience is provided that is consistent, familiar, and easy to use. This is true regardless of the access device used in initiating the transfer.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for mediating a transfer of funds from a sender account to a receiver account, the method comprising:
receiving a transfer request from a sender identifying the sender account and the receiver account, wherein each of the sender account and receiver account is managed by one of a plurality of financial institutions linked by a network according to a common protocol;
issuing a first instruction to debit the sender account in accordance with the transfer request; and
issuing a second instruction to credit the receiver account in accordance with the transfer request,
wherein at least one of the first and second instructions is issued through the network for implementation substantially contemporaneously with receipt of the transfer request.

2. The method recited in claim 1 wherein the transfer request is received from a device associated with an acquiring financial institution comprised by the plurality of financial institutions.

3. The method recited in 2 wherein the device comprises an automatic teller machine.

4. The method recited in claim 2 wherein the acquiring financial institution is the financial institution that manages the sender account.

5. The method recited in claim 4 wherein receiving the transfer request confirms that the sender account includes sufficient funds to execute the transfer request.

6. The method recited in claim 2 wherein the acquiring financial institution is the financial institution that manages the receiver account.

7. The method recited in claim 6 wherein receiving the transfer request confirms that the receiver account is a valid account having no derogatory marks.

8. The method recited in claim 2 wherein the acquiring financial institution manages neither the sender nor receiver account.

9. The method recited in claim 1 wherein the transfer request is received from a device linked with the network but not specifically associated with any of the plurality of financial institutions.

10. The method recited in claim 9 wherein the device is linked with the network through the Internet.

11. The method recited in claim 9 wherein the device is linked with the network through a DTMF processor.

12. The method recited in claim 9 wherein the device is linked with the network through a cable processor.

13. The method recited in claim 1 wherein the sender account and the receiver account are managed by the same financial institution.

14. The method recited in claim 1 wherein the sender account and the receiver account are held in a common name.

15. The method recited in claim 1 wherein the sender account comprises a plurality of sender accounts.

16. The method recited in claim 1 wherein the receiver account comprises a plurality of receiver accounts.

17. The method recited in claim 1 further comprising ensuring that the sender account includes sufficient funds to execute the transfer request.

18. The method recited in claim 17 wherein:
the sender account comprises a noncredit account; and
ensuring that the sender account includes sufficient funds includes ensuring that the sender account includes funds at least as great as a transfer amount specified in the transfer request.

19. The method recited in claim 17 wherein:
the sender account comprises a credit account; and
ensuring that the sender account includes sufficient funds includes ensuring that an available credit balance for the sender account is at least as great as a transfer amount specified in the transfer request.

20. The method recited in claim 1 further comprising ensuring that the receiver account is a valid account having no derogatory marks.

21. The method recited in claim 1 wherein a transfer amount specified in the transfer request is no greater than a common transfer limit of the plurality of financial institutions.

22. The method recited in claim 1 wherein a transfer amount specified in the transfer request is no greater than a lowest of transfer limits specified by each of the plurality of financial institutions.

23. A computer-readable storage medium having a computer-readable program embodied therein for directing operation of a network computer system linking a plurality of financial institutions, the network computer system including a communications device and a processor, wherein the computer-readable program includes instructions for operating the network computer system to mediate a transfer of funds from a sender account to a receiver account, each of the sender account and receiver account being managed by one of the plurality of financial institutions, in accordance with the following:
receiving a transfer request from a sender with the communications device, the transfer request identifying the sender account and the receiver account;
issuing a first instruction with the communications device to debit the sender account in accordance with the transfer request; and
issuing a second instruction with the communications device to credit the receiver account in accordance with the transfer request,
wherein at least one of the first and second instructions is issued for implementation substantially contemporaneously with receipt of the transfer request.

24. The computer-readable storage medium recited in claim 23 wherein the transfer request is received from a device associated with an acquiring financial institution comprised by the plurality of financial institutions.

25. The computer-readable storage medium recited in claim 24 wherein the device comprises an automatic teller machine.

26. The computer-readable storage medium recited in claim 24 wherein the acquiring financial institution is the financial institution that manages the sender account.

27. The computer-readable storage medium recited in claim 26 wherein receiving the transfer request confirms that the sender account includes sufficient funds to execute the transfer request.

28. The computer-readable storage medium recited in claim 24 wherein the acquiring financial institution is the financial institution that manages the receiver account.

29. The computer-readable storage medium recited in claim 28 wherein receiving the transfer request confirms that the receiver account is a valid account having no derogatory marks.

30. The computer-readable storage medium recited in claim 24 wherein the acquiring financial institution manages neither the sender nor receiver account.

31. The computer-readable storage medium recited in claim 23 wherein the transfer request is received from a device linked with the network computer system but not specifically associated with any of the plurality of financial institutions.

32. A network computer system linking a plurality of financial institutions, the network computer system comprising:
a communications device;
a processor in communication with the processor; and
a memory coupled with the processor, the memory comprising a computer-readable storage medium having a computer-readable program embodied therein for operating the network computer system to mediate a transfer of funds from a sender account to a receiver account, each of the sender account and receiver account being managed by one of the plurality of financial institutions, the computer-readable program including:
instructions for receiving a transfer request from a sender with the communications device, the transfer request identifying the sender account and the receiver account;
instructions for issuing a first instruction with the communications device to debit the sender account in accordance with the transfer request; and
instructions for issuing a second instruction with the communications device to credit the receiver account in accordance with the transfer request,
wherein at least one of the first and second instructions is issued for implementation substantially contemporaneously with receipt of the transfer request.

33. The network computer system recited in claim 32 wherein instructions for receiving the transfer request comprise instructions for receiving the transfer request from a device associated with an acquiring financial institution comprised by the plurality of financial institutions.

34. The network computer system recited in claim 33 wherein the device comprises an automatic teller machine.

35. The network computer system recited in claim 33 wherein the acquiring financial institution is the financial institution that manages the sender account.

36. The network computer system recited in claim 33 wherein the acquiring financial institution is the financial institution that manages the receiver account.

37. The network computer system recited in claim 33 wherein the acquiring financial institution manages neither the sender nor receiver account.

38. The network computer system recited in claim 32 wherein instructions for receiving the transfer request comprise instructions for receiving the transfer request from a device linked with the network computer system but not specifically associated with any of the plurality of financial institutions.
